(19) United States
(12) Patent Application Publication
(10) Pub. No.: US 2014/0319717 A1
(43) Pub. Date: Oct. 30, 2014

(54) METHODS FOR PRODUCING BICYCLE SADDLES

(71) Applicant: VELO ENTERPRISE CO., LTD., Taichung City (TW)

(72) Inventor: Tsai-Yun YU, Taichung City (TW)

(73) Assignee: VELO ENTERPRISE CO., LTD., Taichung City (TW)

(21) Appl. No.: 13/955,464

(22) Filed: Jul. 31, 2013

(30) Foreign Application Priority Data
Apr. 30, 2013 (TW) 102115518
Jul. 10, 2013 (TW) 102124765

(51) Int. Cl. B32B 5/20

(52) U.S. Cl. CPC B32B 5/20
USPC 264/46.4; 264/255

(57) ABSTRACT

A method for producing a bicycle saddle including a cover, a shell and a filler. The method is carried out by a mold including upper part with a male portion and a lower part with a female portion, which are pin-jointed together. The method comprises the steps of preheating the mold to a predetermined temperature; opening the mold; treating a layer of release agent onto the surfaces of the male portion and the female portion; spraying a first layer of a first plastic material onto the surface of the female portion treated with the layer of release agent to form a cover; coupling a shell to the male portion; pouring a second layer of a second plastic material onto the female portion; closing the mold and holding it in the closed position a period of time to form the filler; opening the mold to remove the finished saddle.

### BACKGROUND OF THE INVENTION

1. Field of the invention

The present invention relates to bicycle saddles, and particularly relates to a method for producing such saddles.

2. Description of the Prior Art

It is well known that typical bicycle saddles generally comprise a shell made of rigid or semirigid material, a filler made of a resilient material and a cover designed to contact a bicycle user. For producing such conventional saddles, the methods, as disclosed in U.S. Pat. No. 5,904,396 and No. 8,236,218, usually use a pre-formed sheet element made of fabric, leather, imitation leather or the like to be the cover of the saddles. Further speaking, the prior art methods for producing the conventional saddles most often firstly dispose a pre-formed sheet element on a female portion of a mold as the cover, and then pour resin or the like on the upper surface of the sheet element for forming the filler associated with the cover.

The saddles made of the prior art methods have generally an apparent disadvantage that for being pre-formed, the cover can't be bonded tightly with the after-molded filler. And the result is that the cover is easily removed from the filler. Furthermore, there needs many and diverse working procedures, such as, applying, stretching and anchoring procedures, to dispose the pre-formed sheet element on the female portion of the mold so that the labor is consumed and the cost is expensive.

### SUMMARY OF THE INVENTION

The object of the present invention is to overcome the above mentioned drawbacks, by providing a method for producing bicycle saddles that allows the cover and the filler being tightly bonded together.

Another object is to provide a method that allows to minimize product fabrication time and costs.

These and other objects, as better explained hereafter, are achieved by a method for producing a bicycle saddle which at least includes a cover, a rigid or semi-rigid shell and a filler disposed between the cover and the shell. The method is carried out by a mold which includes an upper and lower parts being pin-jointed together for removing between an open position and a closed position. The upper part of the mold has a male portion and the lower part has a female portion opposed to the male portion. The method according to the present invention comprises the following steps: preheating the mold to a temperature in a range of about 30° C. and about 60° C.; opening the mold to the open position; treating a layer of release agent onto the surface of the male portion of the upper part and the surface of the female portion of the lower part; spraying a first layer of a first plastic material onto the surface of the female portion of the lower part treated with the layer of release agent; detachably coupling a shell made of semi-rigid or rigid materials to the male portion of the upper part of the mold; pouring a second layer of a second plastic material in the fluid state onto the female portion of the lower part of the mold; closing the mold to the closed position and maintaining the mold in the closed position a period of time to allow the first layer forming the cover and the second layer forming the filler bonded with the shell and the cover; and opening the mold to remove the finished saddle.

Advantageously, the method further comprises a step of spraying a color layer of a pigment material onto the layer of release agent before the first layer is applied thereonto.

Conveniently, the second plastic material is a foamable polyurethane composition so that a higher resilient and comfortable filler of the saddle is achieved.

Furthermore, there needs a suitable elapsing time between the end of the spraying step of the first layer and the beginning of the pouring step of the second layer for getting a fine bonded condition between the first layer and the second layer.

### BRIEF DESCRIPTION OF THE DRAWINGS

Further features and advantages of the invention will be more apparent from the detailed description of the embodiments according to the present invention, with reference to the accompanying drawings, wherein:

FIG. 1 is a perspective view of a bicycle saddle produced by a method according to one aspect of the present invention;

FIG. 2 is a sectional view of the saddle of FIG. 1, as taken along a line 2-2;

FIGS. 3 and 4 show various steps of the method for producing the saddle of FIG. 1; and

FIG. 5 is a schematic sectional view, taken along a vertical plane, of a mold when performing one of the steps of the method according to the present invention for producing the saddle of FIG. 1.

### DESCRIPTION OF A PREFERRED EMBODIMENT OF THE PRESENT INVENTION

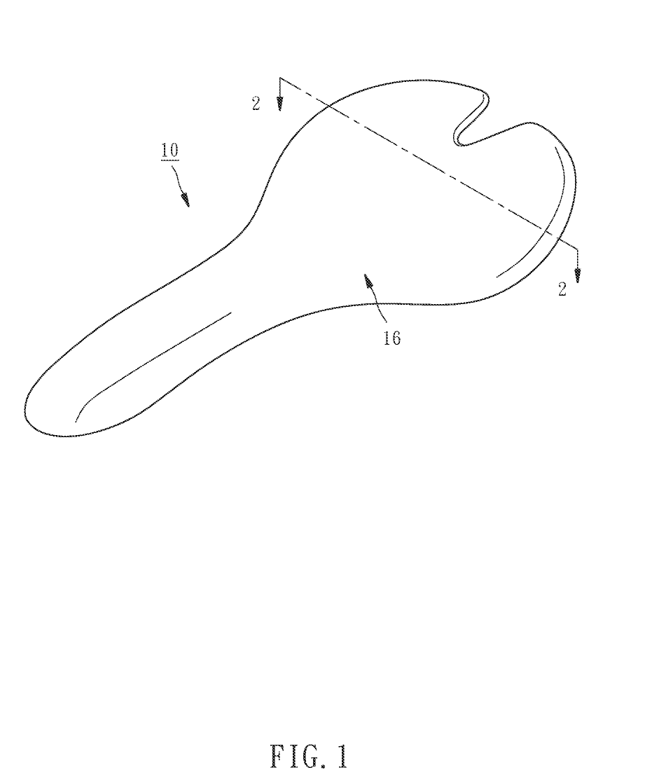

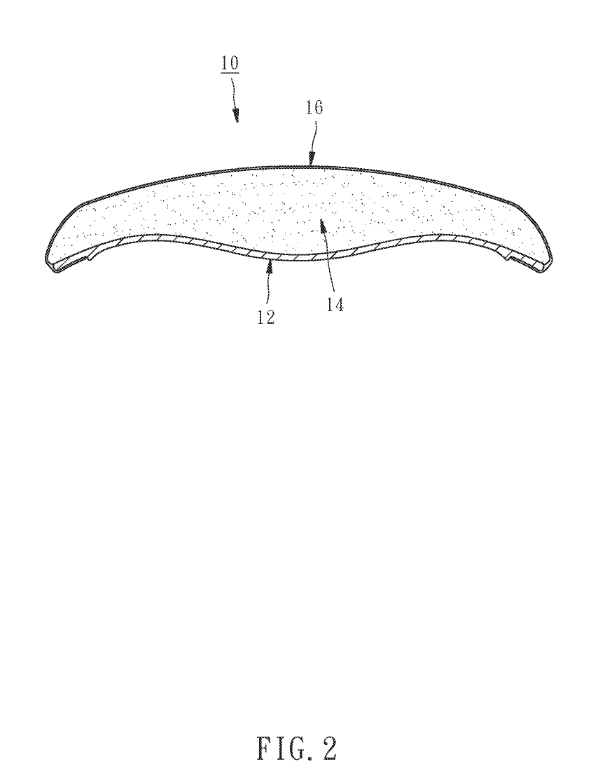

Referring firstly to FIGS. 1 and 2, the saddle 10 is produced by a method according to a preferred embodiment of the present invention. The saddle (10) includes a shell (12), a filler (14) and a cover (16).

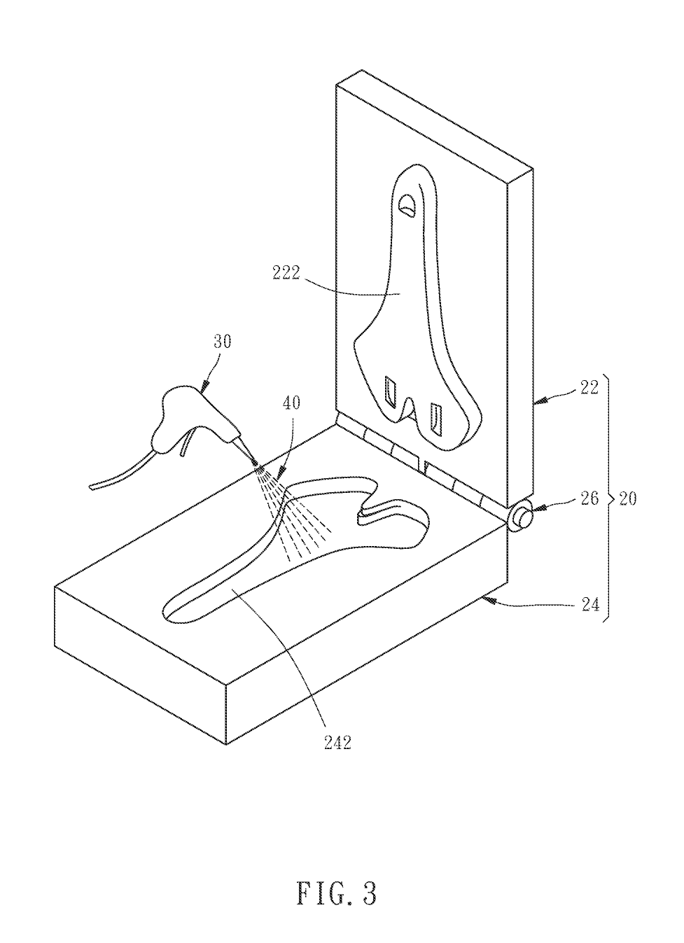

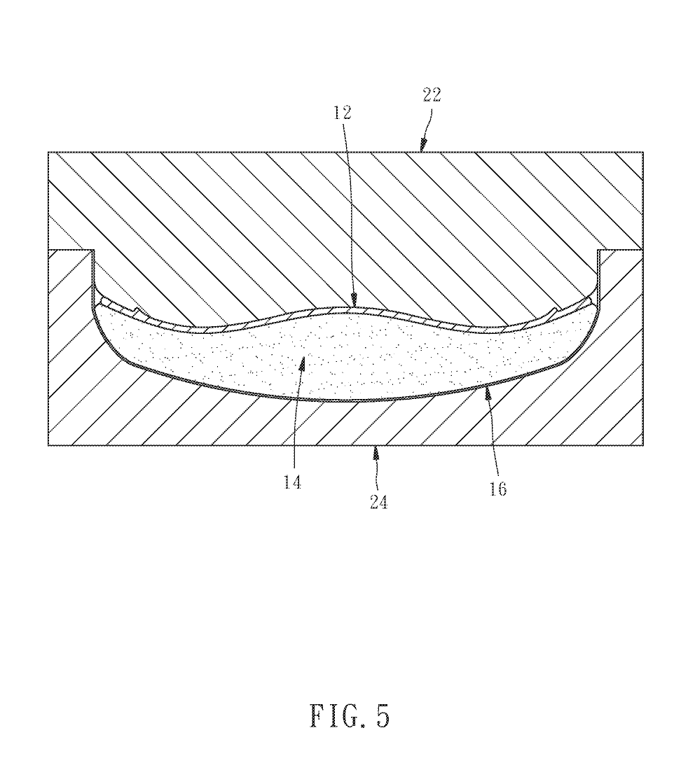

The steps of the method for producing the saddle (10) are schematically shown in FIGS. 3 to 5.

The method advantageously carries out using a mold (20) having an upper part (22) and a lower part (24), which are pin-jointed together by means (26) for being removable between an open position and a closed position. The upper part (22) has a male portion (222) and the lower part (24) has a female portion (242) opposed to the male portion (222) for defining a cavity therebetween as the mold 10 is closed.

The following is the detailed description of the steps of the method for producing the saddle (10).

As a first step, the mold (20) is previously heated to a temperature in a range of about 30° C. and about 60° C., preferably to 45° C. The mold 20 is then opened to the open position and a release agent, such as silicone emulsion, is treated, by a suitable way, such as spray-coating, onto the surface of the male portion (222) and the surface of the female portion (242) to form a layer of release agent.

Then, the cover (16) is formed, by spraying a first layer of a first plastic material (40) onto the surface of the female portion (242) of the lower part (24). Detailedly speaking, as shown in FIG. 3, following the step of treating onto the surface of the female portion (242) the layer of release agent, a first plastic material (40), such as a nonfoamable polyurethane composition, is sprayed onto the surface of the female portion (242) having the layer of release agent treated thereon by a spraying equipment (30) to form the cover (16). In this embodiment, the operating temperature of the first plastic material (40) is kept in a range of about 65° C. and about 75° C., preferably in 70° C. The desired sprayed amount of the first plastic material (40) is controlled in such a way that can keep the thickness of the cover (16) in a range of about 0.7 mm and about 1.2 mm for providing a better protection to the filler (14) and a more comfortable feeling to bicycle riders.

Alternatively, in another embodiment, the cover (16) may be applied a color layer thereon by a step of spraying a color layer of a pigment material onto the layer of release agent before the first layer is applied thereunto. The pigment material can be a polyurethane composition with a pre-selected color.

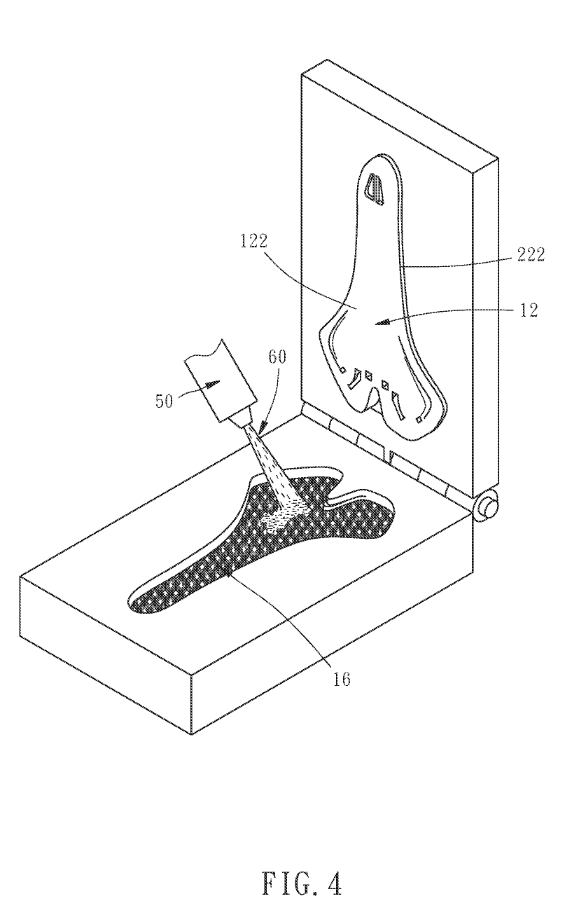

Now, the following step is to couple the frame (12) on the male portion (222) of the upper part (22) of the mold (20) in such a way that the inner surface (122) of the frame (12) is faced to the female portion (242) of the lower part (24) of the mold (20). Then, a second plastic material (60), such as a foamable polyurethane co position, is poured into the female portion (242) having the first layer being applied thereon by a suitable apparatus (50), as shown in FIG. 4. To facilitate the bonded state between the cover (16), the filler (14) and the frame (12), there needs an elapsing time between the end of the step of spraying the first plastic material (40) and the beginning of the step of pouring of the second plastic material (60). The elapsing time may be about 60 seconds to about 90 seconds, preferably 75 seconds.

Once the second plastic material (60) is poured into the female portion (242), the mold (20) is closed and held in the closed position for a period of time, which may be of 4 min to 8 min., so that the filler (11) is formed between the cover (16) and the frame (12), as shown in FIG, 5. After this time, the mold (20) is then opened to remove the finished saddle (10) therefrom, as shown in FIG. 1.

1. A method for producing a bicycle saddle including a cover, a rigid or semi-rigid shell and a filler disposed between said cover and said shell, employing a mold having an upper part and a lower part, said upper part and said lower part being pin-jointed together to be removable between an open position and a closed position, said upper part having a male portion and said lower part having a female portion opposed to said male portion; said method comprising the steps of:
preheating said mold to a temperature in a range of about 30° C. and about 60° C.;
opening said mold to said open position;
treating a layer of release agent onto the surface of said male portion of said upper part and the surface of said female portion of said lower part;
spraying a first layer of a first plastic material onto the surface of said female portion of said lower part treated with said layer of release agent to form a cover;
detachably coupling a shell made of semi-rigid or rigid materials to said male portion of said upper part of said mold;
pouring a second layer of a second plastic material onto said female portion of said lower part of said mold;
closing said mold to said closed position and holding said mold in the closed condition a period of time to allow said second layer forming a filler between said shell and said cover formed by said first layer; and
opening said mold to remove the finished saddle therefrom.

2. The method as claimed in claim 1, further comprising a step of spraying a color layer of a pigment material onto said layer of release agent.

3. The method as claimed in claim 1, wherein said release agent is a silicone emulsion release agent.

4. The method as claimed in claim 1, wherein said first plastic material is a nonfoamable polyurethane composition.

5. The method as claimed in claim 1, wherein said second plastic material is a foamable polyurethane composition.

6. The method as claimed in claim 1, wherein the operating temperature of the first plastic material is kept in a range of about 65° C. and about 75° C.

7. The method as claimed in claim 1, wherein said cover formed by said first plastic material has a thickness in a range of about 0.7 mm and about 1.2 mm

8. The method as claimed in claim 1, wherein there has an elapsing time between the end of the step of spraying of said first plastic material and the beginning of the step of pouring of said second plastic material.

9. The method as claimed in claim 8, said elapsing time is in a range of about 60 seconds and about 90 seconds.

10. The method of claim 4, wherein said second plastic material is a foamable polyurethane composition.
